(19) United States
(12) Patent Application Publication
(10) Pub. No.: US 2014/0103267 A1
(43) Pub. Date: Apr. 17, 2014

(54) METHOD FOR DECORATION OF SILVER ONTO CARBON MATERIALS

(71) Applicant: NATIONAL TSING HUA UNIVERSITY, Hsinchu City (TW)

(72) Inventors: Yu-An LI, Zhongli City (TW); Nyan-Hwa TAI, HsinChu City (TW)

(73) Assignee: National Tsing Hua University, Hsinchu City (TW)

(21) Appl. No.: 13/780,788

(22) Filed: Feb. 28, 2013

(30) Foreign Application Priority Data
Oct. 17, 2012 (TW) 101138167

(51) Int. Cl. H01B 1/02

(52) U.S. Cl. CPC H01B 1/02
USPC 252/514

(57) ABSTRACT

The invention provides a method for decoration of silver onto carbon materials, comprising the following steps: functionalizing a first carbon material and a second material; mixing the functionalized first and second carbon materials into a first mixed solution through an alcohol solution; and mixing a silver solution and the first mixed solution into a second mixed solution.

### BACKGROUND OF THE INVENTION

1. Field of the Invention

This application claims priority of No. 101138167 filed in Taiwan R.O.C. on Oct. 17, 2012 under 35 USC 119, the entire content of which is hereby incorporated by reference.

The invention relates to a method for decoration of silver, particularly to a method for decoration of silver onto carbon materials.

2. Related Art

In the current field of the transparent conducting oxide, indium tin-doped oxide (ITO) is the most research and industrial application.

However, ITO is exposed to aerobic high-temperature (about 300° C.) environment, conductivity of ITO will significantly decrease because of oxygen vacancy. Moreover, the amount indium metal is continuing to decrease and difficult to obtain, price of indium metal will continue to rise, it will also cause the cost of transparent conductive film to increase year by year.

### SUMMARY OF THE INVENTION

An objective of the present invention is to provide a method for decoration of silver onto carbon materials, which is applicable to all carbon materials.

An objective of the present invention is to provide a method for decoration of silver onto carbon materials, which is increasing conductivity of all carbon materials.

An objective of the present invention is to provide a method for decoration of silver onto carbon materials, which is forming a flexible transparent conductive composite.

The invention provides a method for decoration of silver onto carbon materials which comprising: functionalizing a first carbon material and a second carbon material; a mixing step, mixing the functionalized first carbon material and the functionalized second carbon material with an alcohol solution to form a first mixed solution; and mixing a silver ion with the first mixed solution to form a second mixed solution.

### BRIEF DESCRIPTION OF THE DRAWINGS

FIG. 1A shows a schematic diagram illustrating the selected carbon materials.

FIG. 1B shows a schematic diagram illustrating functionalization of the selected carbon materials.

FIG. 1C shows a schematic diagram illustrating mixing of functionalized carbon materials and silver nanoparticles.

FIG. 1D shows a schematic diagram illustrating mixing of the second mixed solution and an organic conductive polymer.

FIG. 2A shows a schematic diagram illustrating sheet resistance of f-CₓG₁₀₋ₓ.

FIG. 2B shows a schematic diagram illustrating the corresponding sheet resistance of f-FWCNTs and f-GNs under different weight percent.

FIG. 3 shows a diagram illustrating relationship between the sheet resistances and the optical transmittances of the flexible transparent conductive films.

FIG. 4 shows a diagram of XRD patterns of GNs, f-GNs, and Ag@f-GNs.

FIG. 5A shows a XPS spectra diagram of C₂G₈, f-C₂G₈, and Ag@f-C₂G₈.

FIG. 5B shows a XPS spectra diagram of Ag@f-C₂G₈ at Ag 3 d region.

FIG. 6 shows a flow chart about decoration of silver onto carbon materials.

### DETAILED DESCRIPTION OF THE INVENTION

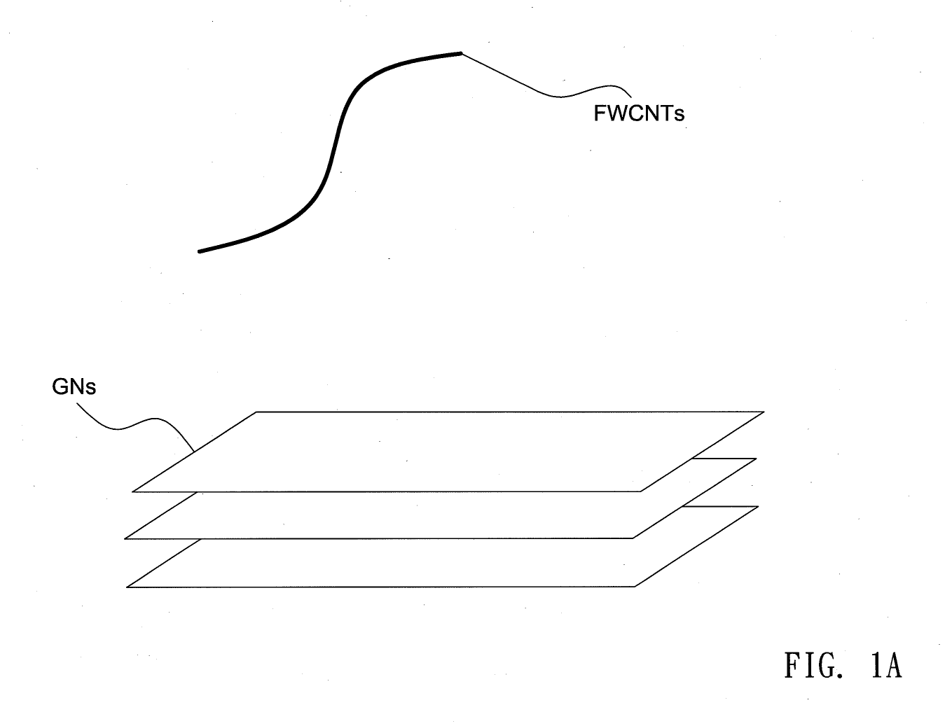

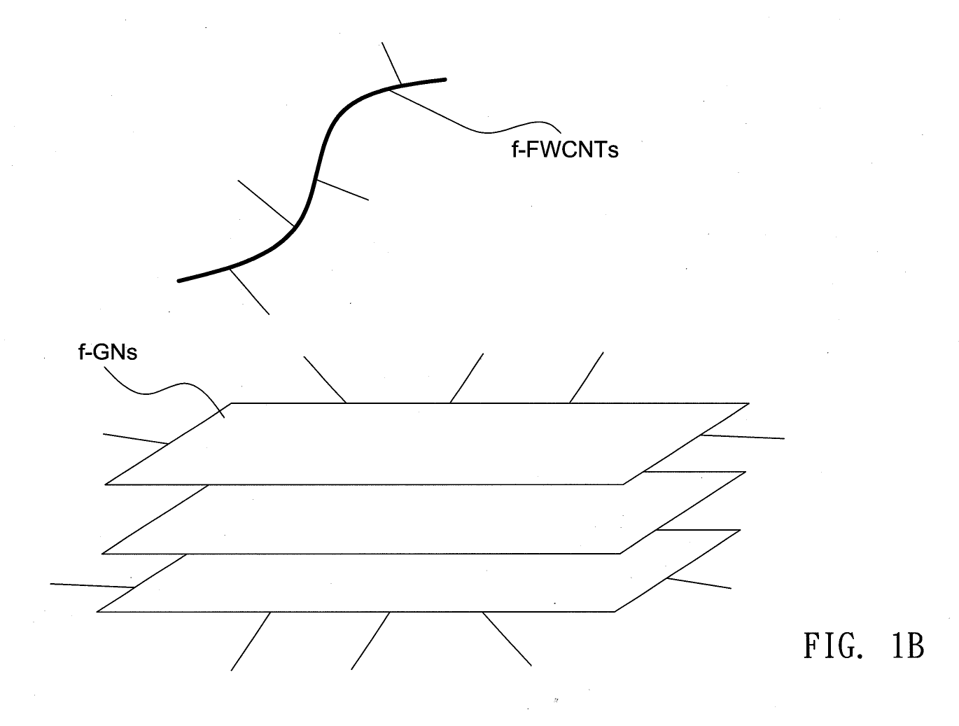

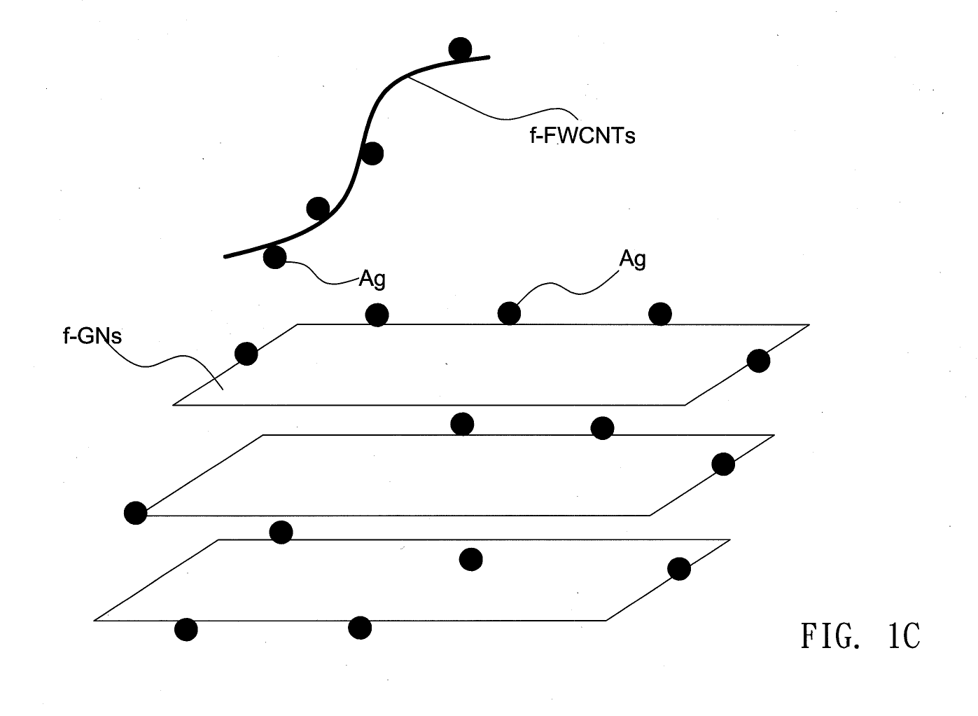

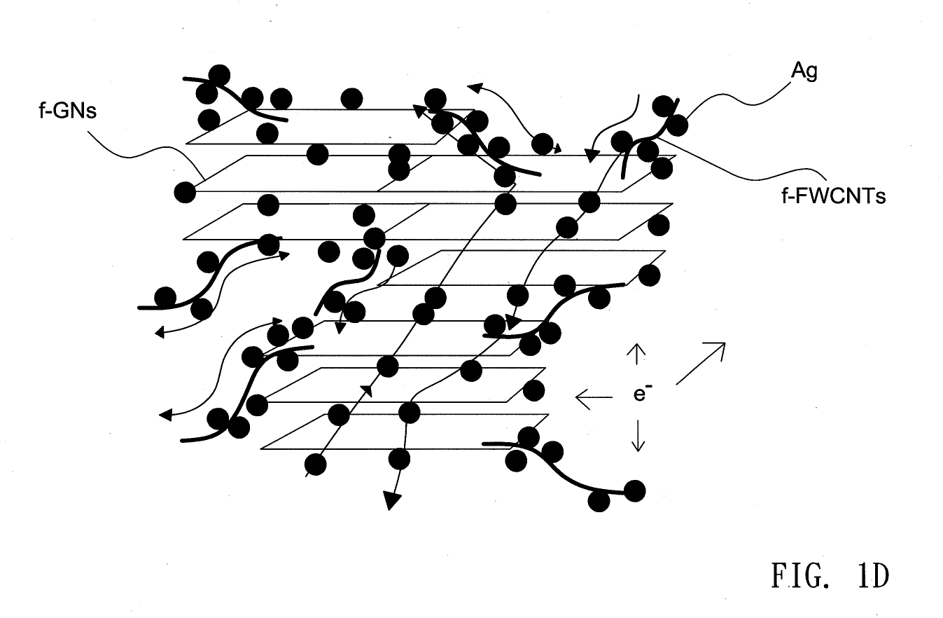

One embodiment of the present invention provides a method for decoration of silver onto carbon materials. Please refer to FIG. 1A, FIG. 1A shows a schematic diagram illustrating the selected carbon materials. In the present embodiment, carbon materials use few-walled carbon nanotubes (FWCNTs) and graphene nanosheets (GNs). It should not be limited in the present invention, carbon materials may use any current or future carbon materials. Wherein, few-walled carbon nanotubes have three to fifteen layers of carbon nanotubes; and GNs have three to fifteen layers of graphite flakes.

It should be noted that, single-walled carbon nanotubes (SWCNTs) contain more than two-thirds of CNTs with semi-conductive property, it causes contact electrical resistance between SWCNTs to be too large to decrease conductivity. As the result, we use FWCNTs in present embodiment.

Then, please refer to FIG. 1B, FIG. 1B shows a schematic diagram illustrating functionalization of the selected carbon materials. In the present invention, the carbon materials are in stable chemical properties, which is without having any functional group on the surface. Therefore, the selected carbon materials are not easily dispersed in an organic solvent or water. As the result, the selected carbon materials are functionalized through a strong acid. In the present embodiment, FWCNTs and GNs are individually immersed into a 3:1 v/v mixture of concentrated H₂SO₄ and HNO₃ and sonicated for one hour.

In the present embodiment, functionalized FWCNTs (abbreviation is f-FWCNTs) and functionalized GNs(abbreviation is f-GNs) mix with an alcohol solution to form a first mixed solution. The alcohol solution can be implemented by ethanol.

It should be noted that, the aforementioned mixing step can be implemented by another embodiment. f-FWCNTs and f-GNs are individually mixed with an alcohol solution to form a first solution and a second solution in first. Then, we mix the first solution with the second solution to form the first mixed solution.

Finally, please refer to FIG. 1C, FIG. 1C shows a schematic diagram illustrating mixing of functionalized carbon materials and silver nanoparticles. In the present invention, silver ions mix with the first mixed solution to form a second mixed solution and complete the decoration of silver onto carbon materials. In the embodiment, silver ions are reduced from silver nitrate (AgNO₃).

The electrostatic attraction between the carboxyl groups on the f-FWCNTs and the f-GNs can cause the migration of Ag ions, which are reduced from AgNO₃, to the surfaces of the f-FWCNTs and the f-GNs. Then, Ag ions are reduced to silver nanoparticles by ethanol, silver nanoparticles are deposited on surface of the f-FWCNTs and the f-GNs to complete the decoration of silver.

Otherwise, ethanol plays dual roles as a solvent and as a weak reagent for reducing Ag ions to Ag nanoparticles. The Ag ions are supplied from AgNO₃ dissolved in the ethanol solution and diffused them onto the surfaces of f-FWCNTs and f-GNs, subsequently reacting with grafted OH⁻ groups on those surfaces to form Ag₂O nanoparticles. These Ag₂O nanoparticles are then reduced by the ethanol in situ and deposited Ag nanoparticles on the surfaces of f-FWCNTs and f-GNs. The process can be expressed by the following equations (1)˜(4):

2Ag⁺+2OH⁻_{ads}→Ag₂O_{ads}+H₂O (1)

Ag₂O_{ads}+CH₃CH₂OH→CH₃CHO+2Ag_{ads}+H₂O (2)

Ag₂O_{ads}+CH₃CHO→CH₃COO⁻+2Ag_{ads}+H⁺ (3)

H⁺+OH⁻_{ads}→H₂O (4)

The overall reaction can be written as following equation (5):

4Ag⁺+5OH⁻_{ads}+CH₃CH₂OH→CH₃COO⁻+4Ag_{ads}+4H₂O (5)

Wherein, OH⁻_{ads}, Ag₂O_{ads}, and Ag_{ads} refer to the OH⁻ groups, the Ag₂O intermediates, and the Ag nanoparticles that are ad-sorbed onto the surfaces of f-FWCNTs or f-GNs. Ag₂O is reduced to Ag nanoparticles, The ethanol is oxidized to acetaldehyde and then to acetate as the final product while reducing the Ag₂O nanoparticles to Ag nanoparticles. The process can be expressed by the following equations (6)˜(8):

Ag₂O+2H⁺+2e⁻→2Ag+H₂O (6)

CH₃CH₂OH→CH₃CHO+2H⁺+2e⁻ (7)

CH₃COO⁻+2H⁺+2e⁻→CH₃CHO+H₂O (8)

Please refer to FIG. 1D, FIG. 1D shows a schematic diagram illustrating mixing of the second mixed solution and an organic conductive polymer. In the present invention, the second mixed solution mixes with an organic conductive polymer to form flexible transparent conductive film (TCFs). It should be noted that, organic conductive polymer can be implemented by poly (3,4-ethylenedioxythiophene)-poly(4-stryrenesulfonate) (PEDOT:PSS) in this embodiment.

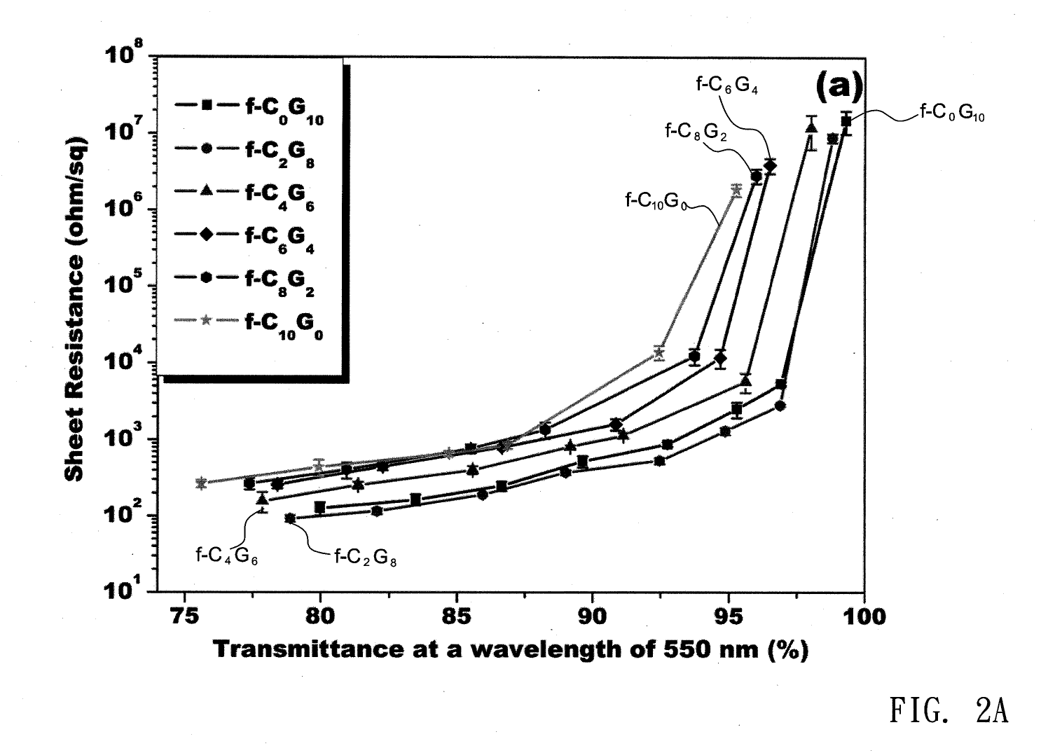

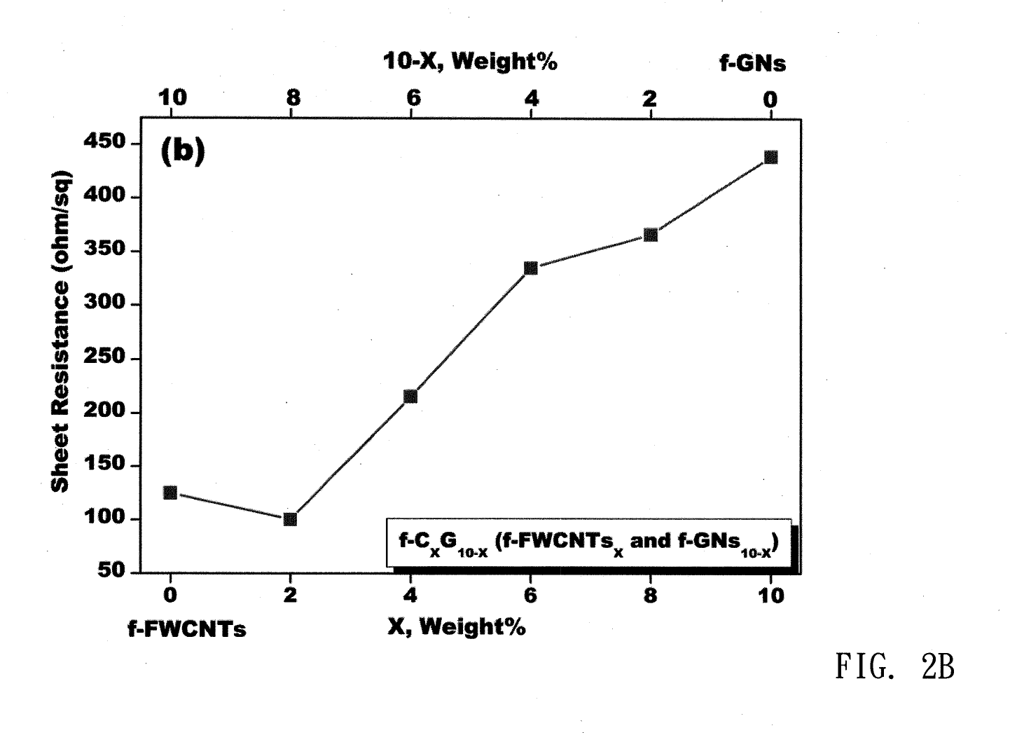

Moreover, the present invention utilizes TCFs, which are manufactured from f-FWCNTs and f-GNs, to make sheet resistance test. Please also refer to FIGS. 2A and 2B. FIG. 2A shows a schematic diagram illustrating sheet resistance of f-CₓG₁₀₋ₓ. FIG. 2B shows a schematic diagram illustrating the corresponding sheet resistance of f-WCNTs and f-GNs under different weight percent (wt %). When 2.0 wt % of f-FWCNTs and 8.0 wt % of f-GNs are used, the TCFs will have an extremely low sheet resistance.

The present invention utilizes Ag ions, which are supplied from AgNO₃, to increases the electron hole concentration in the PEDOT:PSS and carbon materials (the f-FWCNTs and the f-GNs), therefore enhancing the electrical conductivity of these materials. Wherein, we refer to Ag nanoparticles, distributed on the surfaces of the f-FWCNTs, as Ag@f-FWCNTs; and we refer to Ag nanoparticles, distributed on the surfaces of the f-GNs, as Ag@f-GNs.

In one embodiment, When a PEDOT:PSS matrix containing 2.0 wt % of Ag@f-FWCNTs and 8.0 wt % of Ag@f-GNs are coated onto a poly(ethylene terephthalate) film, outstanding optoelectronic properties of the film with a sheet resistance of 50.3 ohm/sq and a transmittance of 79.73% at a wavelength of 550 nm are achieved.

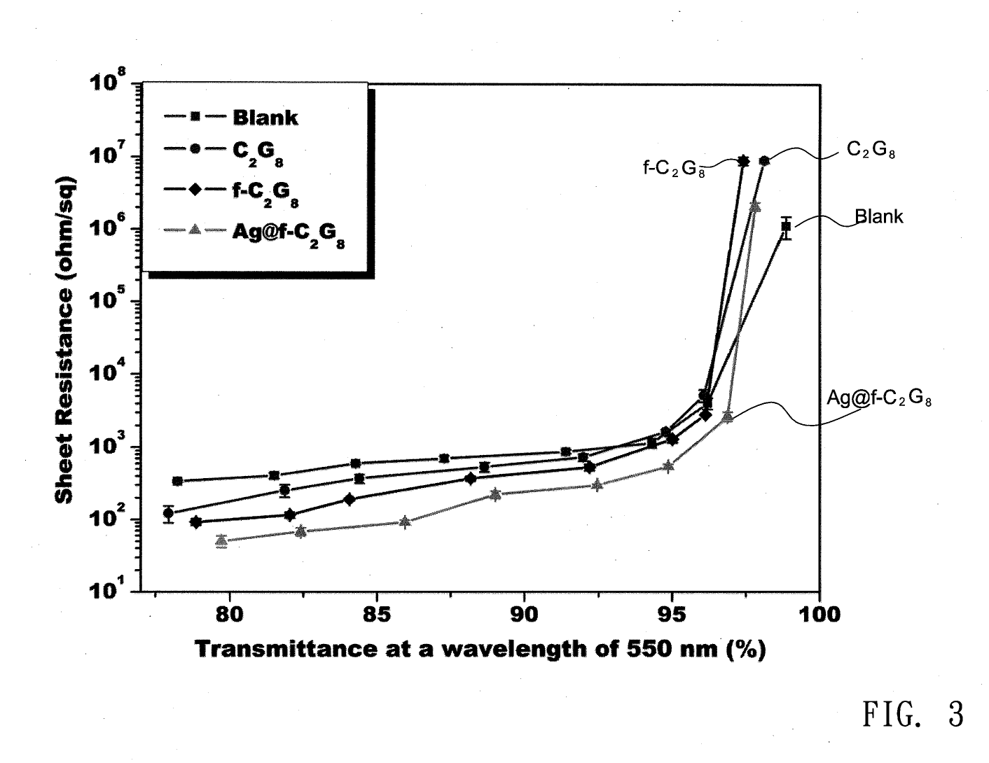

Then, please refer to FIG. 3, FIG. 3 shows a diagram illustrating relationship between the sheet resistances and the optical transmittances of the flexible transparent conductive films. The Blank film refers to the PEDOT:PSS-based TCFs that do not contain any fillers; the C₂G₈ film refers to the PEDOT:PSS-based TCFs that contain 2.0 wt % of FWCNTs and 8.0 wt % of GNs; the f-C₂G₈ film refers to the PEDOT:PSS-based TCFs that contain 2.0 wt % of f-FWCNTs and 8.0 wt % of f-GNs; and the Ag@f-C₂G₈ film refers to the PEDOT:PSS-based TCFs that contain 2.0 wt % of Ag@f-FWCNTs and 8.0 wt % of Ag@f-GNs.

However, for a transmittance that is lower than 95%, the sheet resistance of the Blank sample is kept within the range of 102 to 103 ohm/sq. The use of FWCNTs and GNs as hybrid fillers reduced the electrical sheet resistance of the TCFs significantly. The f-C₂G₈ film exhibits a better performance in terms of electrical sheet resistance than the C₂G₈ film because the functionalization process generates a p-dopant effect on the functionalized fillers, which decreases the overall electrical resistivity of the film. The film incorporated with Ag@f-C₂G₈ possesses a sheet resistance of 50.3 ohm/sq and a transmittance of 79.73%. The sheet resistance was only 15% of that exhibited by the Blank sample which performed the sheet resistance and transmittance of 339 ohm/sq and 78.25%, respectively, because the Ag nanoparticles generated more conductive pathways to lower the electrical resistance of the film and decrease thickness of TCFs.

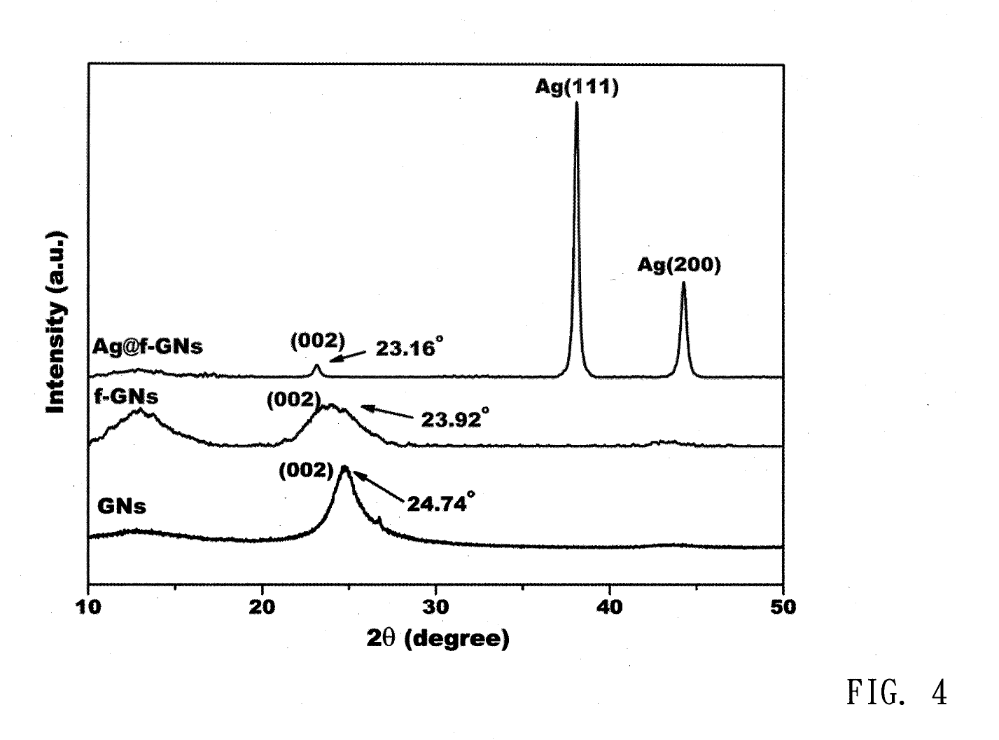

Please refer to FIG. 4, FIG. 4 shows a diagram of XRD patterns of GNs, f-GNs, and Ag@f-GNs. The major peaks at 24.74° for GNs, 23.92° for f-GNs, and 23.16° for Ag@f-GNs represent the hexagonal (002) graphene plane corresponding to interlayer distances of 0.359, 0.372, and 0.384 nm for GNs, f-GNs, and Ag@f-GNs. Wherein, θ is the diffraction angle. The change in the diffraction angle by a magnitude of 1.58° from 24.74° for GNs to 23.16° for Ag@f-GNs illustrates the intercalation of Ag ions and/or Ag nanoparticles, which can cause an expansion of the graphitic interlayer after the Ag ions have been reduced. The intercalations of Ag ions and/or Ag nanoparticles can increase the conductive pathways between the interlayers of GNs. In other words, Ag nanoparticles can increase the conductivity between f-GNs by increasing the conductive pathways. Furthermore, the peaks at 38.10° and 44.28° correspond to the (111) and the (200) planes of the face-centered cubic Ag nanoparticles.

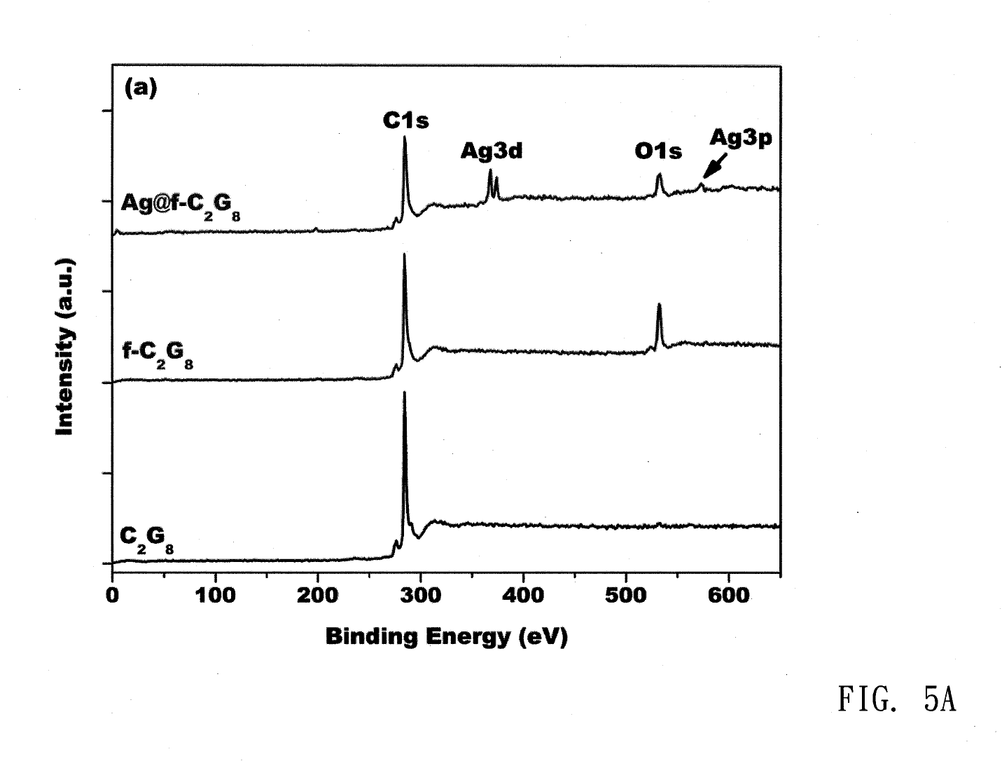

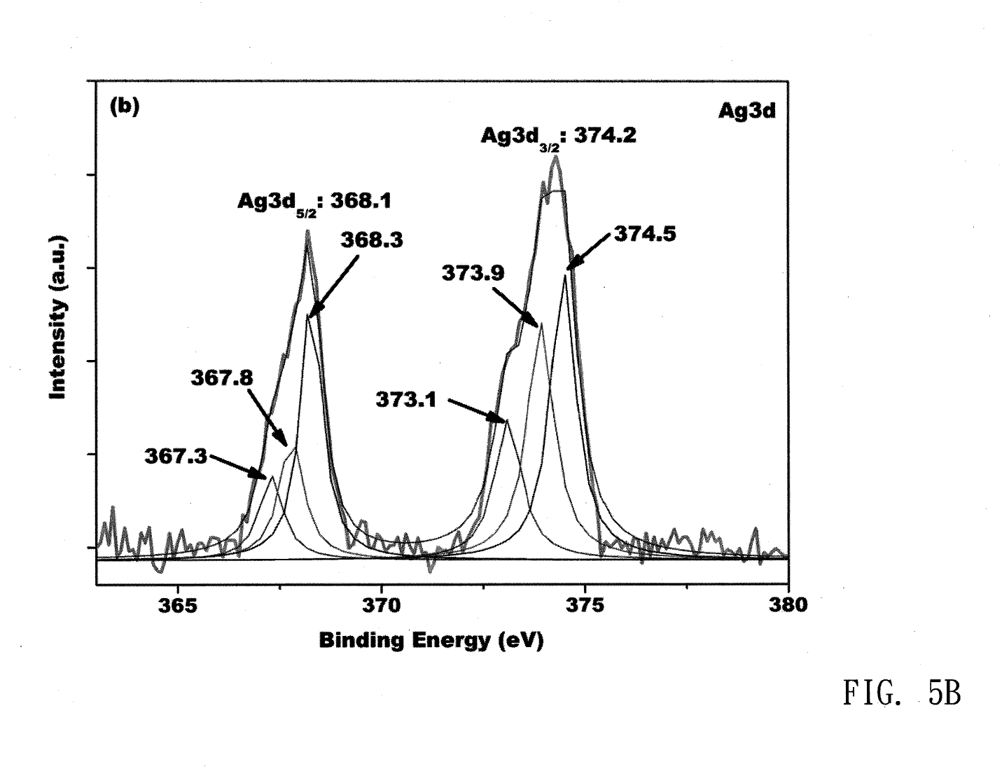

Please refer to FIG. 5A, FIG. 5A shows a XPS spectra diagram of C₂G₈, f-C₂G₈, and Ag@f-C₂G₈. As shown in FIG. 5A, only the Cls can be detected in the C₂G₈ filler and no Ols peak can be found indicating high purity of the C₂G₈ filler. The Ols peak is detected in the f-C₂G₈ filler due to graft of carboxyl groups on the carbon material during the functionalization process. After Ag decoration, the Ag 3p and Ag 3d signals can be observed in the Ag@f-C₂G₈ filler.

Please refer to FIG. 5B, FIG. 5B shows a XPS spectra diagram of Ag@f-C₂G₈ at Ag3d region. Among the Ag 3d spectra, the doublet can be identified at 368.1 and 374.2 eV correspond to the chemical state of 3d_{5/2} and 3d_{3/2}, respectively. It is suggested that these two peaks correspond well to oxide-free Ag metallic nanoparticles. Furthermore, the Ag 3d_{5/2}peak can be resolved into three individual component peaks, located at 367.3, 367.8, and 368.3 eV, corresponding to AgO, Ag₂O, and Ag metallic state, respectively. 45 The Ag metallic state is dominating in the Ag@f-C₂G₈ filler because it has the largest area among these three fitted curves, indicating that the majority of the nanoparticles deco-rated on the carbon material surfaces are metallic Ag. The existence of AgO and Ag₂O may arise from the intermediates during Ag decoration when ionic Ag reacted with the carboxyl groups. In addition, the slight shifts of these three fitted peaks toward a higher binding energy by 0.1-0.3 eV, as compared with the results reported for the Ag oxides and metal, are attributed to the presence of more electronegative oxygen atoms present from the functional groups on the carbon surfaces.

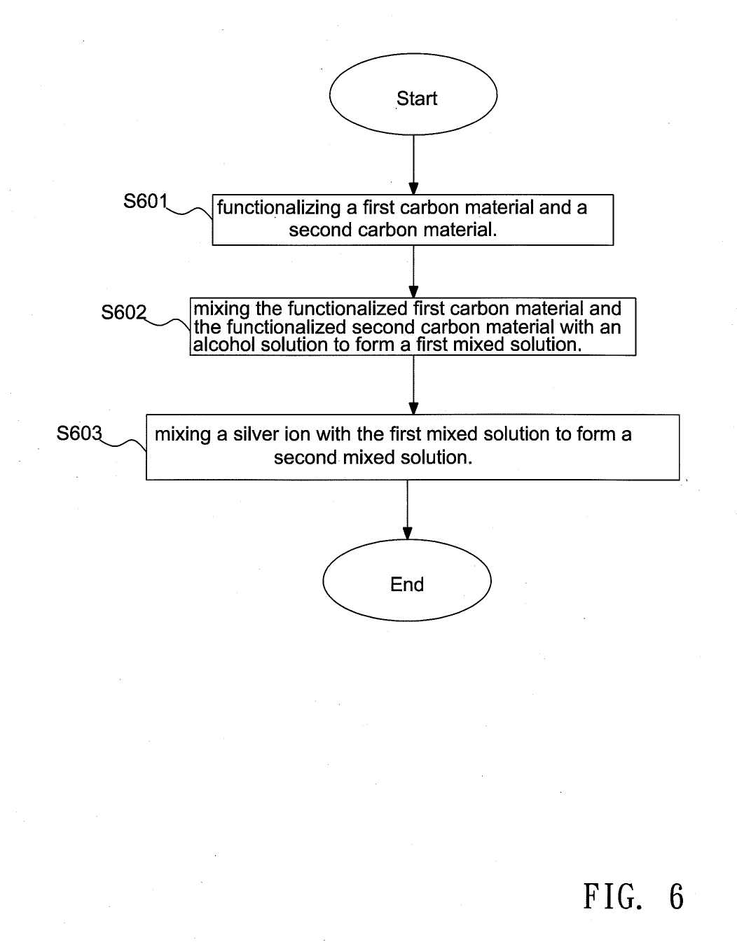

Please refer to FIG. 6, FIG. 6 shows a flow chart about decoration of silver onto carbon materials. The method for decoration of silver onto carbon materials comprise the following steps:

Step S601: functionalizing a first carbon material and a second carbon material.

Step S602: mixing the functionalized first carbon material and the functionalized second carbon material with an alcohol solution to form a first mixed solution.

Step S603: mixing a silver ion with the first mixed solution to form a second mixed solution.

While the present invention has been described by the way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

In conclusion, Ag@f-FWCNTs and Ag@f-GNs are mixed into the PEDOT:PSS matrix not only formed a three-dimensional network but also increased the contact points between the Ag nanoparticles and the fillers, resulting in increase in the number of electrical conductive pathways. In addition, the reduction of Ag ions to Ag nanoparticles increased the concentration of holes in both the fillers and the polymer matrix, leading to a reduction in the contact resistance. After Ag decoration, homogenous Ag nanoparticles are distributed uniformly on the surfaces of f-FWCNTs and f-GNs. Moreover, Ag ions and/or Ag nanoparticles can intercalate into the GN interlayer and expand the spacing between graphitic layers, which results in the increase of conductive pathways between interlayer between GNs. Ethanol was used both as a solvent and as an electron donor to dissolve and to reduce the Ag ions. When 2.0 wt % of Ag@f-FWCNTs and 8.0 wt % of Ag@f-GNs were used as fillers in the PEDOT:PSS matrix, the TCFs with an extremely low sheet resistance of 50.3 ohm/sq and a high transmittance of 79.73% at a wavelength of 550 nm were achieved. Therefore, the present invention can improve defects of original TCFs.

What is claimed is:

1. A method for decoration of silver onto carbon materials which comprising:
functionalizing a first carbon material and a second carbon material;
a mixing step, mixing the functionalized first carbon material and the functionalized second carbon material with an alcohol solution to form a first mixed solution; and
mixing a silver ion with the first mixed solution to form a second mixed solution.

2. The method according to claim 1, wherein the first carbon material comprises a carbon nanotube and the second carbon material comprises a graphene nanosheet.

3. The method according to claim 2, wherein the method further comprising:
mixing the second mixed solution with an organic conductive polymer to form a flexible transparent conductive film.

4. The method according to claim 3, wherein the carbon nanotube is a few-walled carbon nanotubes (FWCNTs).

5. The method according to claim 4, wherein the few-walled carbon nanotubes have three to fifteen layers of carbon nanotubes.

6. The method according to claim 5, wherein the organic conductive polymer is PEDOT:PSS.

7. The method according to claim 5, wherein the alcohol solution is an ethanol.

8. The method according to claim 6, wherein the silver ion is generated by silver nitrate (AgNO₃); and the silver ion increases hole concentration of PEDOT:PSS and conductivity of the flexible transparent conductive film.

9. The method according to claim 8, wherein the mixing step comprises:
mixing the functionalized first carbon material with the alcohol solution to form a first solution;
mixing the functionalized second carbon material with the alcohol solution to form a second solution; and
mixing the first solution with the second solution to form the first mixed solution.

10. The method according to claim 8, wherein the first carbon material and the second carbon material is functionalized through a strong acid.
